(19) United States
(12) Patent Application Publication
(10) Pub. No.: US 2026/0045533 A1
(43) Pub. Date: Feb. 12, 2026

(54) SUPPORT APPARATUS AND SUPPORT METHOD

(71) Applicant: SK On Co., Ltd., Seoul (KR)

(72) Inventors: Dae Soo HAN, Daejeon (KR); Hyeong Uk RYU, Daejeon (KR); Do Hyun LEE, Daejeon (KR); Hyun Woo CHOI, Daejeon (KR)

(21) Appl. No.: 19/277,389

(22) Filed: Jul. 23, 2025

(30) Foreign Application Priority Data
Aug. 12, 2024 (KR) 10-2024-0107458

(51) Int. Cl. H01M 10/04; F16B 7/22; H01M 10/0525

(52) U.S. Cl. CPC H01M 10/0409; F16B 7/22; H01M 10/0525

(57) ABSTRACT

A support apparatus includes a support member into which a target object is inserted, an anti-separation member in which an anti-separation region, at least a portion of the anti-separation member, is exposed to the outside of the support member, a driving unit connected to the anti-separation member, and a pressing portion connected to the driving unit and having at least a portion exposed to the outside of the support member, wherein the driving unit moves the anti-separation member when the pressing portion is pressed.

### CROSS-REFERENCE TO RELATED APPLICATION(S)

This patent document claims the priority and benefits of Korean Patent Application No. 10-2024-0107458 filed on Aug. 12, 2024, the disclosure of which is incorporated herein by reference in its entirety.

### TECHNICAL FIELD The present disclosure relates to a support apparatus and a support method.

### BACKGROUND

Batteries have been widely used in small electronic devices, such as mobile phones and laptops, as well as medium and large-sized mechanical devices, such as electric vehicles (EVs), and have the advantage of being rechargeable and reusable.

An electrode assembly may include an electrode plate including a positive electrode plate and a negative electrode plate and a separator separating the positive electrode plate and the negative electrode plate.

The electrode plate may be manufactured as a positive electrode plate or a negative electrode plate by applying a positive electrode active material or a negative electrode active material to a current collecting plate, a current collector.

The current collecting plate or electrode plate may be wound around a core. The wound electrode plate or current collecting plate may be transported to an electrode manufacturing process or a battery cell manufacturing process in a wound state.

The wound current collecting plate or electrode plate needs to be supported or transported in each process.

### SUMMARY

The present disclosure may be implemented in some embodiments to provide a support apparatus and a support method, capable of improving efficiency in the work of supporting a target object, such as an electrode plate.

The present disclosure may be implemented in some embodiments to provide a support apparatus and a support method, capable of improving safety in the work of supporting a target object.

In addition, the present disclosure may be widely applied in green technology fields, such as solar power generation and wind power generation.

In addition, the present disclosure may be applied to eco-friendly devices, such as eco-friendly electric vehicles and hybrid vehicles to prevent climate change by suppressing air pollution and greenhouse gas emissions.

In some embodiments of the present disclosure, a support apparatus includes: a support member into which a target object is inserted; an anti-separation member in which an anti-separation region, at least a portion of the anti-separation member, is exposed to the outside of the support member; a driving unit connected to the anti-separation member; and a pressing portion connected to the driving unit and having at least a portion exposed to the outside of the support member, wherein the driving unit moves the anti-separation member when the pressing portion is pressed.

The anti-separation region may face the target object from the outside of the support member, and when the pressing portion is pressed, the driving unit may move the anti-separation region such that the anti-separation region does not face the target object.

The support member may include: a hollow portion provided inside the support member; and a first through-hole into which the anti-separation member may be inserted, wherein the driving unit may be disposed in the hollow portion.

The driving unit may return the anti-separation member to an initial position of the anti-separation member when pressing force is released from the pressing portion.

The support member may include: at least one second through-hole; and a moving guide portion disposed in the at least one second through-hole, at least a portion of the moving guide portion being exposed to the outside of the support member and contacting the target object.

The at least one second through-hole may include a plurality of second through-holes arranged in a length direction of the support member, and the moving guide portion may be provided in plural and the plurality of moving guide portions may be arranged in the plurality of second through-holes, respectively.

The moving guide portion may include: a guide rotation shaft connected to the support member; and a moving guide roller supported by the guide rotation shaft.

The driving unit may include: a first driving link disposed in the hollow portion and connected to the anti-separation member; a second driving link connected to the first driving link and the pressing portion; and an elastic support portion disposed in the hollow portion and connected to the second driving link and the support member.

The elastic support portion may include: a first fixed block fixed to the support member; a first elastic member having one side connected to the first fixed block and the other side connected to the second driving link; a second fixed block fixed to the support member; and a second elastic member having one side connected to the second fixed block and the other side connected to the second driving link.

The driving unit further may include: at least one stopper member disposed in the hollow portion and limiting movement of the pressing portion and the second driving link.

The driving unit may include: a driving shaft disposed in the hollow portion and connected to the anti-separation member; a rotation block connected to the driving shaft and pressed by the pressing portion to be rotated; and a torsion spring connected to the rotation block and the support member.

The pressing portion may include a pressed member including a pressure rod pressing the rotation block, and the rotation block may include: a first inclined surface in contact with the pressure rod and may be inclined; and a first step portion connected to one side of the first inclined surface and protruding in a length direction of the rotation block.

The anti-separation region may be disposed in the hollow portion when the rotation block completes rotation in a clockwise direction and may be disposed outside the support member when the rotation block completes rotation in a counterclockwise direction.

The support apparatus may further include a carriage body to which the support member is fixed.

The carriage body may include at least one moving wheel.

The moving guide roller may include a buffer member on an outer surface of the moving guide roller.

In some embodiments of the present disclosure, a support method may include: a preparation operation of pressing a pressing portion exposed to the outside of a support member to move an anti-separation member into the inside of the support member to support a target object; a moving operation of moving the target object to the support member, while the pressing portion may be being pressed; and a supporting operation of releasing the pressing of the pressing portion to expose the anti-separation member to the outside of the support member.

The moving operation may include moving the target object in a length direction of the support member in a state in which the target object may be brought into contact with a moving guide roller provided in the support member.

### BRIEF DESCRIPTION OF DRAWINGS

Certain aspects, features, and advantages of the present disclosure are illustrated by the following detailed description with reference to the accompanying drawings.

FIG. 1 is a schematic exploded perspective view of a support apparatus and a target object according to an embodiment of the present disclosure;

FIG. 2 is a schematic perspective view of a support apparatus according to an embodiment of the present disclosure, illustrating a state before the target object is supported by the support apparatus;

FIG. 3 is a cross-sectional view schematically illustrating line A-A′ of FIG. 1;

FIG. 4 is a cross-sectional view schematically illustrating line A-A′ of FIG. 1;

FIG. 5 is a cross-sectional view schematically illustrating line A-A′ of FIG. 1, illustrating a driving unit according to another embodiment of the present disclosure;

FIG. 6 is a cross-sectional view schematically illustrating A-A′ of FIG. 1, illustrating an operating state of FIG. 5;

FIG. 7 is a schematic perspective view of a rotation block according to an embodiment of the present disclosure;

FIG. 8 is a side view illustrating a position of a pressure rod when force for pressing a pressing member is not applied;

FIG. 9 is a side view illustrating a position of a pressure rod when force for pressing a pressing member is applied;

FIG. 10 is a perspective view illustrating a portion of a rear surface of a rotation block according to an embodiment of the present disclosure, illustrating a joint portion of a torsion spring and a rotation block;

FIG. 11 is a plan view schematically illustrating a support member according to another embodiment of the present disclosure;

FIG. 12 is a schematic right side view of FIG. 11;

FIG. 13 is a schematic diagram illustrating a state in which a target object is supported by a support member according to an embodiment of the present disclosure, illustrating a state in which a pressure member presses a pressing member;

FIG. 14 is a schematic diagram illustrating a state in which a pressure member releases the pressure of a pressing member;

FIG. 15 is a schematic perspective diagram of a support apparatus according to another embodiment of the present disclosure; and

FIG. 16 is a schematic diagram illustrating a support method according to an embodiment of the present disclosure.

### DETAILED DESCRIPTION

In order to help understanding of the description of the embodiments of the present disclosure, elements denoted with the same reference numerals in the accompanying drawings are the same elements. Some components in the accompanying drawings are exaggerated, omitted, or schematically illustrated, and the size of each component does not completely reflect the actual size.

In addition, in order to clarify the gist of the present disclosure, descriptions of elements and techniques well known in the art may be omitted, and hereinafter, the present disclosure is described in detail with reference to the accompanying drawings.

Hereinafter, the X-axis illustrated in the drawing is a length direction of a target object 10, and the Y-axis and Z-axis are a width direction or thickness direction of the target object 10. However, these are directions arbitrarily set for convenience of understanding, and the directions may be changed.

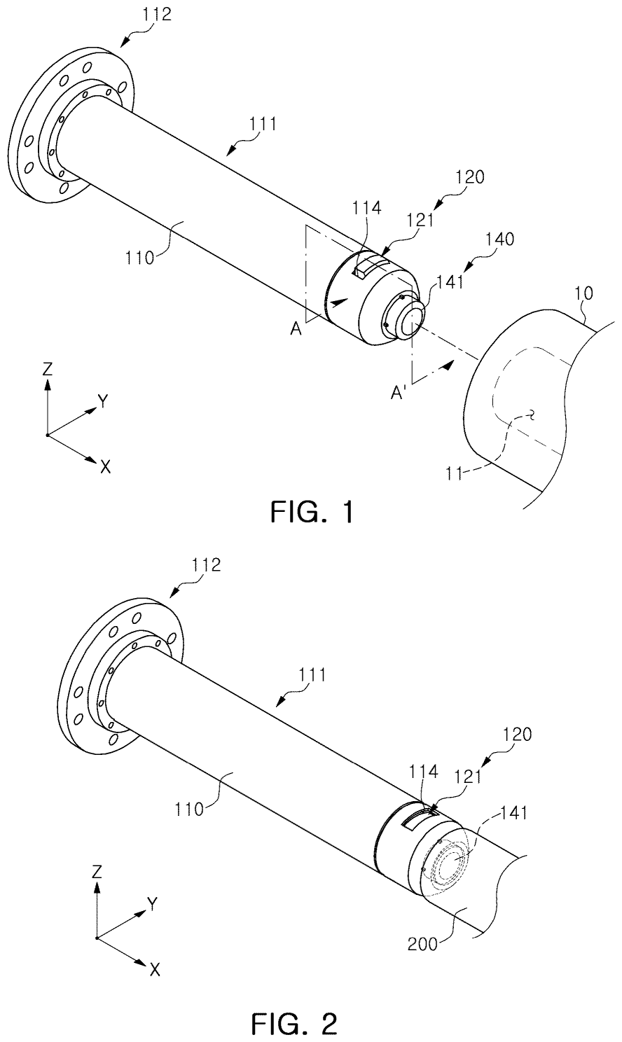

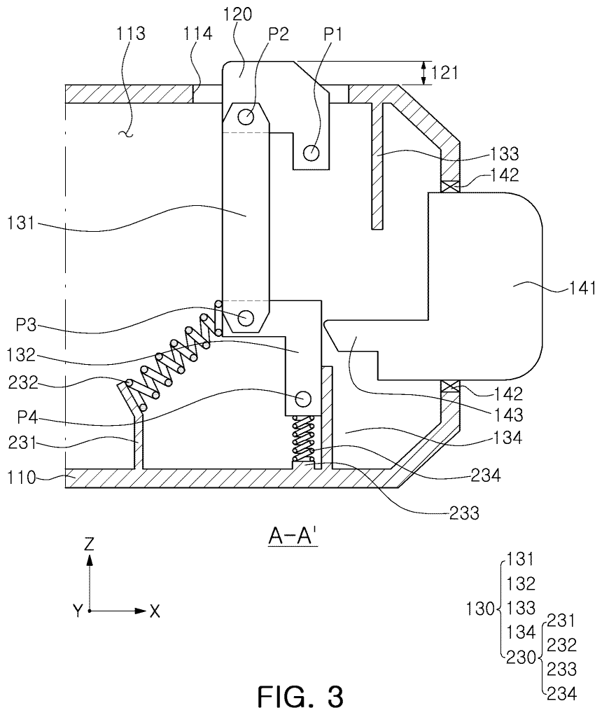

FIG. 1 is a schematic exploded perspective view of a support apparatus and the target object 10 according to an embodiment of the present disclosure, FIG. 2 is a schematic perspective view of the support apparatus according to an embodiment of the present disclosure, illustrating a state before the target object 10 is supported by the support apparatus, and FIG. 3 is a cross-sectional view schematically illustrating A-A′ of FIG. 1.

First, as illustrated in FIGS. 1 and 3, the support apparatus according to an embodiment of the present disclosure includes a support member 110 into which the target object 10 is inserted, an anti-separation member 120 in which an anti-separation region 121, which is at least a portion thereof, is exposed to the outside of the support member 110, a driving unit 130 connected to the anti-separation member 120, and a pressing portion 140 connected to the driving unit 130 and having at least a portion exposed to the outside of the support member 110, and the driving unit 130 may move the anti-separation member 120 when the pressing portion 140 is pressed.

The target object 10 may be a current collecting plate or an electrode plate. The electrode plate may be in a state in which an electrode active material is applied to the current collecting plate. For example, when a positive electrode active material is applied to a positive electrode current collecting plate, the positive electrode current collecting plate may become a positive electrode plate, and when a negative electrode active material is applied to a negative electrode current collecting plate, the negative electrode current collecting plate may become a negative electrode plate. For example, the electrode plate may be an electrode plate of a lithium ion battery cell.

The target object 10 may be wound around a core 11. The target object 10 may have a reel shape.

The support member 110 may have a shaft or pipe shape and may extend by a certain length in the length direction (X-axis direction) of the target object 10. The support member 110 may be inserted into the core 11 of the target object 10. Or the core 11 of the target object 10 may be inserted into the support member 110.

The target object 10 may be supported by the support apparatus as the core 11 is completely inserted into the support member 110. A length of the support member 110 in the X-axis direction may exceed a length of the target object 10 in the X-axis direction. Accordingly, the target object 10 may be prevented from being separated from the support member 110 and the target object 10 may be stably supported.

In an embodiment, the support member 110 includes a hollow portion 113 provided therein and a first through-hole 114 into which the anti-separation member 120 is inserted, and the driving unit 130 may be disposed in the hollow portion 113.

The support member 110 may have a hollow shaft or pipe shape, and the empty space formed inside the support member 110 may be the hollow portion 113.

The support member 110 may include at least one first through-hole 114 on an outer surface thereof. The first through-hole 114 may be a through-hole penetrating through the support member 110.

At least a portion of the anti-separation member 120 may be disposed in the hollow portion 113, and at least another portion of the anti-separation member 120 may be exposed to the outside of the support member 110. The portion of the anti-separation member 120 exposed to the outside of the support member 110 may be an anti-separation region 121.

The anti-separation member 120 may be connected to the driving unit 130 inside the hollow portion 113, and the anti-separation region 121 may be inserted into the first through-hole 114. The anti-separation region 121 may be exposed to the outer surface of the support member 110 by passing through the first through-hole 114.

The anti-separation region 121 may protrude by a certain length in a +Z-direction from the outer surface of the support member 110. The anti-separation region 121 may be maintained in a state of being exposed to the outside of the first through-hole 114 in a normal state. In the normal state, the support member 110 may not support the target object 10.

The driving unit 130 may be disposed in the hollow portion 113 and may be connected to the anti-separation member 120, the support member 110, and the pressing portion 140.

In an embodiment, the pressing portion 140 may include a pressed member 141 exposed to the outside of the support member 110 in at least a portion thereof. The pressed member 141 may include a pressure rod 143 pressing the driving unit 130, and the pressure rod 143 may be disposed in the hollow portion 113.

A friction reducing member 142 may be provided between the outer surface of the pressed member 141 and the support member 110. The friction reducing member 142 may include a ball bearing or the like, but a type of the friction reducing member 142 is not necessarily limited by the present disclosure.

The pressed member 141 may be pressed from the outside of the support member 110 and moved in the −X-direction. The friction reducing member 142 may guide the movement of the pressed member 141 in the X-axis direction. In addition, the friction reducing member 142 may prevent damage to the pressed member 141 and the support member 110 due to excessive friction between the pressed member 141 and the support member 110.

The pressed member 141 may be pressed by an operator from the outside of the support member 110 or by a separate device.

The pressed member 141 may be pressed before the support member 110 is inserted into the core 11 of the target object 10 or before inserting the core 11 of the target object 10 into the support member 110. while the pressed member 141 is maintained in a state of being pressed in the −X-direction, the anti-separation region 121 may be maintained in a state of being introduced into the first through-hole 114 and the anti-separation member 120 and the anti-separation region 121 are maintained to be located in the hollow portion 113.

In an embodiment, the anti-separation region 121 faces the target object 10 from the outside of the support member 110, and the driving unit 130 may move the anti-separation region 121 when the pressing unit 140 is pressed so that the anti-separation region 121 may not face the target object 10.

The anti-separation region 121 may maintain a state of being exposed to the outside of the support member 110 in a normal state, and the state in which the anti-separation region 121 is exposed to the outside of the support member 110 may be an initial state of the anti-separation region 121.

The anti-separation region 121 may be in a state of being introduced into the inside of the support member 110 through the first through-hole 114, while the target object 10 is inserted into the support member 110. Thereafter when the target object 10 is completely inserted into the support member 110, the anti-separation region 121 may be restored to the initial state and maintained in a state of being exposed to the outside of the support member 110.

While the pressed member 141 is being pressed, the anti-separation region 121 may be located inside (or in the hollow portion 113 of) the support member 110 so as not to be exposed to the outside of the support member 110, and when the pressed member 141 is released from the pressed state, the anti-separation region 121 may be exposed to the outside of the support member 110

In an embodiment, the first through-hole 114 may be disposed to be adjacent to an end portion of the support member 110 or the pressed member 141 in the +X-direction. The first through-hole 114 may be a hole penetrating through the support member 110 in the Z-direction.

The anti-separation region 121 and the anti-separation member 120 may be inserted into the first through-hole 114. The anti-separation region 121 may be exposed to the outside of the support member 110 through the first through-hole 114.

In an embodiment, the support member 110 may include a support region 111 and a connection portion 112 connected to the support region 111. The support region 111 may be formed on an outer surface of the support member 110, and a length of the support region 111 in the X-axis direction may be a certain length of the support member 110 in the length direction (X-axis direction). The support region 111 may face the core 11 of the target object 10 and may support the target object 10.

The target object 10 may be inserted into the support member for the core 11 to pass by the end portion of the support member 110 to a position at which the core 11 of the target object 10 faces the support region 111.

The target object 10 may be inserted into the support member 110 for the core 11 to pass by the anti-separation region 121 to a position at which the core 11 of the target region 10 faces the support region 111.

While the core 11 of the target object 10 is inserted into the support member 110, the anti-separation region 121 may be maintained in a state of not protruding to the outside of the support member 110.

The connection portion 112 may be connected in the −X-direction of the support region 111 and may be spaced apart from the anti-separation member 120 with the support region 111 in between. The connection portion 112 may include at least one bracket, at least one connection hole penetrating through the at least one bracket and may be utilized to connect or secure the support member 110 to another device.

As illustrated in FIGS. 1 and 2, when the pressed member 141 is pressed in the −X-direction, the anti-separation region 121 may be introduced into the inside of the support member 110. When the pressed member 141 is pressed, the anti-separation region 121 may not protrude from the outer surface of the support member 110 in the +Z-direction. Therefore, interference between the anti-separation region 121 and the target object 10 may be prevented, while the core 11 of the target object 10 is being into the support member 110.

When the core 11 of the target object 10 is completely inserted into the support member 110, pressing the pressed member 141 may be released so that the anti-separation region 121 may protrude again to the outside of the support member 110. The anti-separation region 121 may face the side of the target object 10 and may prevent the target object 10 from escaping from the support member 110 in the +X-direction. Accordingly, the support efficiency of the target object 10 may be improved, and the target object 10 may be stably supported.

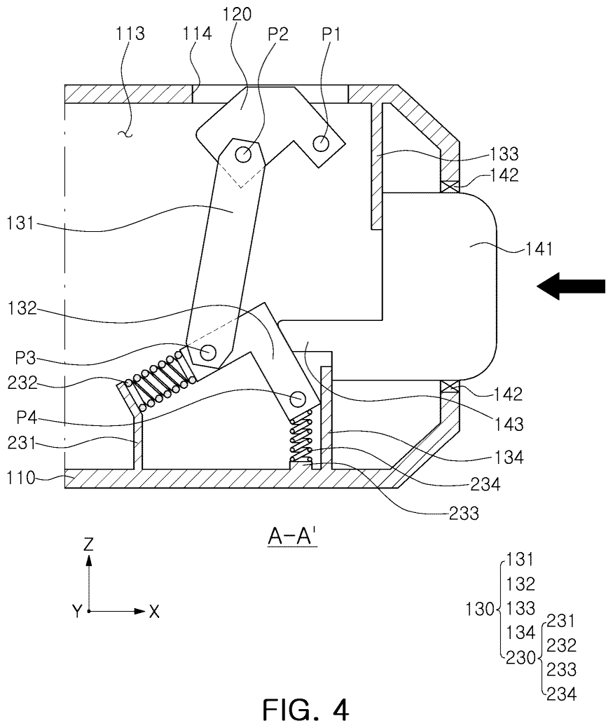

FIG. 4 is a cross-sectional view schematically illustrating A-A′ of FIG. 1. FIG. 4 illustrates a state in which a second driving link 132 is pressed by the pressure rod 143 of the pressed member 141.

As illustrated in FIGS. 3 and 4, one side of the anti-separation member 120 in the hollow portion 113 may be connected to the support member 110 by a first fixing member P1, and the other side of the anti-separation member 120 may be connected to the driving unit 130 by a second fixing member P2. The first fixing member P1 and the second fixing member P2 may be hinges.

In an embodiment of the present disclosure, the driving unit 130 may include a first driving link 131 disposed in the hollow portion 113 of the support member 110 and connected to the anti-separation member 120, a second driving link 132 connected to the first driving link 131 and the pressed member 141, and an elastic support member 230 disposed in the hollow portion 113 and connected to the second driving link 132 and the support member 110.

One side of the first driving link 131 may be connected to the anti-separation member 120 by the second fixing member P2, and the other side of the first driving link 131 may be connected to the second driving link 132 by a third fixing member P3.

One side of the second driving link 132 may be connected to the first driving link 131 by the third fixing member P3, and the other side of the second driving link 132 may be connected to the support member 110 by a fourth fixing member P4. The third fixing member P3 and the fourth fixing member P4 may be hinges.

In an embodiment, in the second driving link 132, one side may be connected to the first driving link 131 and the other side may be bent to face the pressure rod 143 of the pressed member 141. The second driving link 132 may be pressed by the pressure rod 143 to be rotated. To this end, the second driving link 132 may be elastically supported by the elastic support member 230. The elastic support member 230 may move the pressed member 141 to the original position thereof when force pressing the pressed member 141 is removed.

In an embodiment, the elastic support member 230 may include a first fixed block 231 fixed to the support member 110, a first elastic member 232 having one side connected to the first fixed block 231 and the other side connected to the second driving link 132, a second fixed block 233 fixed to the support member 110, and a second elastic member 234 having one side connected to the second fixed block 233 and the other side connected to the second driving link 132.

The first fixed block 231 may support the first elastic member 232. The first elastic member 232 may be connected to the second driving link 132 and the first fixed block 231 and may be pressed by the second driving link 132. The first elastic member 232 may include an elastic material and may be a spring, for example.

The first elastic member 232 may be pressed by a counterclockwise rotation of the second driving link 132 and may be tensioned by a clockwise rotation of the second driving link 132. The first elastic member 232 may be a tension spring, for example. The first elastic member 232 may be contracted in length when the second driving link 132 is rotated in the counterclockwise direction and may be restored to its initial position by elastic force when the second driving link 132 is rotated in the clockwise direction.

The second driving link 132 may maintain a state of being rotated in the counterclockwise direction, while being pressed by the pressure rod 143 of the pressed member 141. When force pressing the pressed member 141 is removed, the second driving link 132 may rotate in the clockwise direction and be restored to the original position as the pressure rod 143 retreats in the +X-direction. At this time, the second driving link 132 may rotate in the clockwise direction by elastic force of the first elastic member 232. Therefore, the pressed member 141 may be pushed by the second driving link 132 and moved in the +X-direction. Accordingly, the end portion of the pressed member 141 may protrude to the outside of the support member 110.

The second fixed block 233 may support the second elastic member 234. The second elastic member 234 may be connected to the second driving link 132 and the second fixed block 233, and may be, for example, a compression spring. The second elastic member 234 may maintain a tensioned state in the +Z-direction, while the pressure rod 143 presses the second driving link 132. At this time, the first elastic member 232 may be in a contracted state.

When force pressing the pressure rod 143 is removed, the second elastic member 234 may be compressed or contracted in length and may be restored to its original length. At this time, the second driving link 132 may rotate in the clockwise direction by restoring force of the second elastic member 234 and may be returned to its original position. Therefore, the second driving link 132 may return the position of the pressed member 141 to its original position. The original position of the pressed member 141 may be a position at which at least a portion of the pressed member 141 including an end portion of the pressed member 141 protrudes by a certain length in the +X-direction from the outer surface of the support member 110.

In an embodiment, the driving unit 130 may further include at least one stopper member disposed in the hollow portion 113 and limiting movement of the pressed member 141 and the second driving link 132.

The at least one stopper member may include a first stopper member 133 extending from an inner surface of the support member 110 toward the hollow portion 113 and a second stopper member 134 extending from the inner surface of the support member 110 toward the hollow portion 113.

The first stopper member 133 may face at least a portion of the pressed member 141 in the hollow portion 113 and may set a limit of movement of the pressed member 141 in the-X-direction. The first stopper member 133 may limit the movement of the pressed member 141 in the hollow portion 113. The pressed member 141 in contact with the first stopper member 133 may be limited in the movement in the-X-direction.

The second stopper member 134 may face the second driving link 132 in the hollow portion 113 and may limit the movement of the second driving link 132 in the hollow portion 113. When the second driving link 132 is in contact with the second stopper member 134, the movement of the second driving link 132 may be limited. The contact between the second drive link 132 and the second stopper member 134 may be made when the second drive link 132 is pressed by the pressure rod 143 and the movement in the counterclockwise direction based on the Y-axis as a rotation axis is completed.

In an embodiment, the second drive link 132 may be in contact with one side of the second stopper member 134 in the-X-direction, and the pressed member 141 may be in contact with the other side of the second stopper member 134 in the +X-direction. When the pressed member 141 is in contact with the other side of the second stopper member 134 in the +X-direction, the movement of the pressed member 141 in the −X-direction may be limited.

The pressed member 141 may be pressed in the −X-direction by the operator or a separate device, and force applied at this time may be force pressing the pressed member 141. In this case, the pressed member 141 may be moved in the −X-direction. The pressure rod 143 may press the second driving link 132 to rotate the second driving link 132 in the counterclockwise direction as illustrated in FIG. 4.

While the second driving link 132 is pressed by the pressure rod 143, force pressing the pressed member 141 may be continuously applied. Here, the anti-separation member 120 may be rotated in the counterclockwise direction, and the anti-separation region 121 of the anti-separation member 120 may be introduced into the inside of the first through-hole 114 and not protrude from the outer surface of the support member 110.

In this state, when the core 11 of the target object 10 is inserted into the support member 110, the target object 10 may be inserted into the support member 110 without interference between the anti-separation region 121 and the target object 10.

In an embodiment, the driving unit 130 may return the position of the anti-separation member 120 to the original position or initial position when force pressing the pressed member 141 is removed. The driving unit 130 may return the anti-separation member 120 to the initial position when force pressing the second driving link 132 is removed. Therefore, the anti-separation region 121 may protrude to the outside of the first through-hole 114.

The initial position of the anti-separation member 120 may be a position of the anti-separation member 120 when force pressing the pressed member 141 is not applied and may be a position at which the anti-separation region 121 is exposed to the outside of the support member or at which the anti-separation region 121 protrudes to the outside of the support member.

When force pressing the pressed member 141 is removed, force pressing the second driving link 132 may also be removed. When force pressing the second driving link 132 is removed, as described above, the second driving link 132 may rotate in the clockwise direction about the Y-axis as a rotation axis to return to the original position.

Accordingly, the first driving link 131 may rotate to rotate the anti-separation member 120 in the clockwise direction When the clockwise rotation of the anti-separation member 120 is completed, the anti-separation region 121 may protrude outwardly from the support member 110 and the pressed member 141 may be pressed by the second driving link 132 to protrude in the +X-direction. After the pressed member 141 is pressed by the second driving link 132 to be restored to the initial position, the end portion of the pressed member 141 in the +X-direction and at least a portion of the region including the end portion may be in a state of protruding in the +X-direction by a certain length from the support member 110.

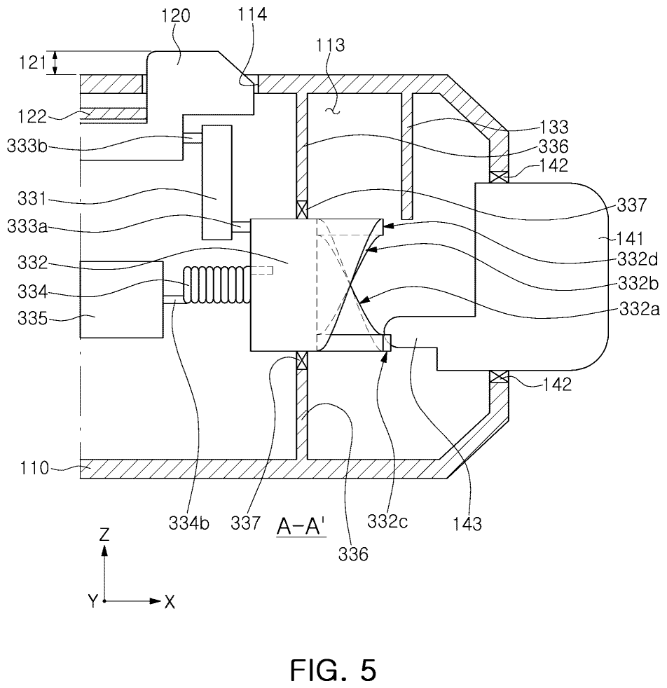

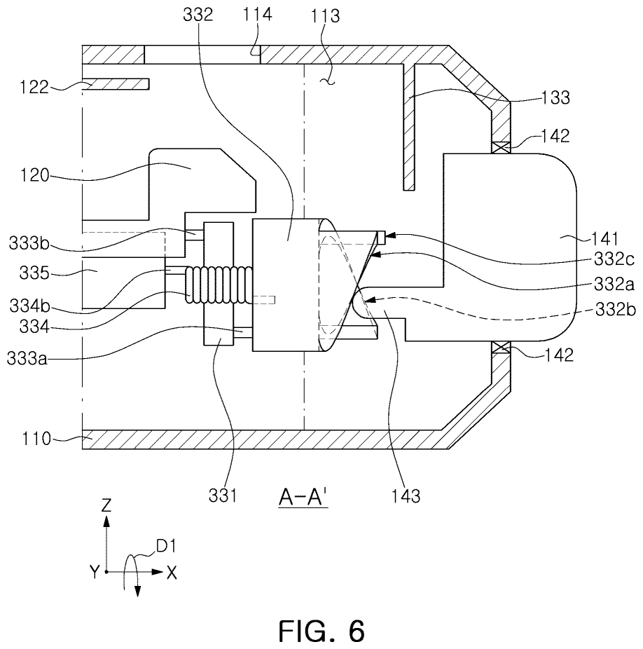

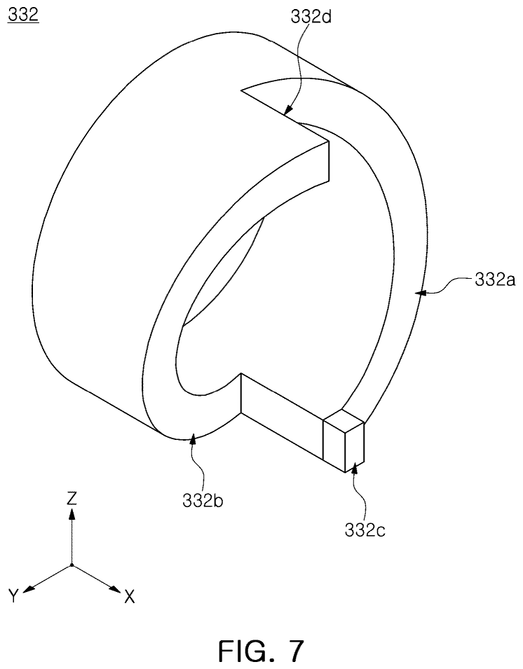

FIG. 5 is a cross-sectional view schematically illustrating A-A′ of FIG. 1, illustrating the driving unit 130 according to another embodiment of the present disclosure, FIG. 6 is a cross-sectional view schematically illustrating A-A′ of FIG. 1, illustrating an operating state of FIG. 5, and FIG. 7 is a schematic perspective view of a rotation block 332 according to an embodiment of the present disclosure.

As illustrated in FIGS. 5 to 7, the driving unit 130 according to another embodiment of the present disclosure may include a driving shaft 331 disposed in the hollow portion 113 of the support member 110 and connected to the anti-separation member 120, the rotation block 332 eccentrically connected to the driving shaft 331 and pressed by the pressing portion 140 to be rotated, and a torsion spring 334 connected to the rotation block 332 and the support member 110.

In an embodiment, a first connection shaft 333a may be connected to a back surface (or rear surface) of the rotation block 332 in the −X-direction. The first connection shaft 333a may not face the center or centroid of the rotation block 332. The first connection shaft 333a may not face the center or centroid of the rotation block 332 in a Y-Z plane and may be eccentrically connected to the rotation block 332.

The first connection shaft 333a may also be connected to the driving shaft 331. Accordingly, the driving shaft 331 may move when the rotation block 332 rotates.

A second connection shaft 333b may be connected to the back surface (or rear surface) of the driving shaft 331 in the-X-direction. The second connection shaft 333b may connect the driving shaft 331 to the anti-separation member 120. For example, the second connection shaft 333b may be a hinge. Accordingly, the anti-separation member 120 may move in the −Z-direction and the +Y-direction when the rotation block 332 rotates.

In an embodiment, in order to limit the movement of the anti-separation member 120, a first support bracket 122 may be provided in the hollow portion 113 of the support member 110. The first support bracket 122 may be connected to an inner surface of the support member 110 and may limit the movement of the anti-separation member 120 in the +Z-direction. However, this is not necessarily limited by the present disclosure.

In addition, in an embodiment, another support bracket may be provided to limit the movement of the anti-separation member 120 in the-Z-direction. However, this is not necessarily limited by the present disclosure.

A torsion spring 334 may be connected to a rear surface of the rotation block 332 in the-X-direction. The torsion spring 334 may connect the rotation block 332 to a second support bracket 335. The second support bracket 335 may be connected to the inner surface of the support member 110.

The torsion spring 334 may be rotated or twisted based on the X-axis as a rotation axis between the rotation block 332 and the second support bracket 335. The torsion spring 334 may be rotated or twisted when the rotation block 332 rotates about the X-axis as a rotation axis.

When force pressing the pressed member 141 is applied to the rotation block 332, the rotation block 332 is pressed by the pressure rod 143 of the pressed member 141 and may rotate in the clockwise direction D1 about the X-axis as a rotation axis in the Y-Z plane.

When force pressing the pressed member 141 is removed, the rotation block 332 may rotate in the counterclockwise direction in the Y-Z plane and move the pressure rod 143 in the +X-direction. Here, the pressed member 141 may protrude from the support member 110 in the +X-direction and return to the initial position.

In an embodiment, when the clockwise D1 rotation of the rotation block 332 is completed, the anti-separation member 120 may be introduced into the hollow portion 113, and the anti-separation region 121 may be disposed in the hollow portion 113. Here, the anti-separation region 121 may not protrude from the outer surface of the support member 110.

Meanwhile, the counterclockwise rotation of the rotation block 332 may be made by elastic force of the torsion spring 334. When force pressing the pressed member 141 is removed, the torsion spring 334 may rotate the rotation block 332 in the counterclockwise direction by elastic restoring force.

In an embodiment, when the counterclockwise rotation of the rotation block 332 is completed, the anti-separation member 120 may be discharged to the outside of the hollow portion 113, and the anti-separation region 121 may protrude to the outside of the support member 110 so as to be disposed on the outer surface of the support member 110.

The rotation block 332 may be rotated in the counterclockwise direction and returned to its original position, and the pressed member 141 may also be returned to its initial position during the returning process of the rotation block 332. However, the rotation directions may be applied interchangeably with each other and are not necessarily limited by the present disclosure.

The rotation block 332 may be connected to the support member 110 by at least one connection block 336 or the like. At least one side of the connection block 336 may be connected to the inner surface of the support member 110, and the other side of the connection block 336 may be connected to the outer surface of the rotation block 332 by a bearing 337 or the like. For example, the connection block 336 may be provided in plural. The connection block 336 may support the rotation block 332 so that the rotation block 332 may rotate in the hollow portion 113.

In some cases, at least one connection block 336 may be connected to the outer surface of the rotation block 332 by a ball bearing or the like, but the method of supporting a load of the rotation block 332 is not necessarily limited by the present disclosure.

In an embodiment, the rotation block 332 may include a first inclined surface 332a in contact with the pressure rod 143, a first step portion 332c connected to one side of the first inclined surface 332a and protruding in the length direction (X-axis direction) of the rotation block 332, and a second step portion 332d connected to the other side of the first inclined surface 332a and protruding in the length direction of the rotation block 332.

The first inclined surface 332a may be an inclined plane, and the first step portion 332c may be a region having the highest height in the X-axis direction in the rotation block 332. The first step portion 332c may be a protruding region of the rotation block 332. The height of the first step portion 332c in the X-axis direction may be higher than the height of the second step portion 332d in the X-axis direction.

The second step portion 332d may be connected to a point (lowest surface) having the lowest height in the X-axis direction on the first inclined surface 332a, may be in contact with the lowest surface of the first inclined surface 332a, may be perpendicular to or intersecting with the Y-axis and the Z-axis, and may be a plane, parallel to the X-axis. The second step portion 332d may be a plane protruding in the length direction of the rotation block 332 or the +X-direction from the lowest surface of the first inclined surface 332a. For example, the second step portion 332d may include a plane parallel to the X-Z plane. In one example, the second step portion 332d may be a plane parallel to the X-Z plane. When the second step portion 332d is a plane parallel to the X-Z plane, the plane may be in contact with the lowest region of the first inclined surface 332a in the-X direction. In addition, the plane may be perpendicular to or intersect with the Y-Z plane and/or the X-Y plane.

The second inclined surface 332b may be connected to the second step portion 332d. The second inclined surface 332b may be an inclined surface connecting the plane extending the first step portion 332c in the-X-direction and the second step portion 332d. The plane extending the first step portion 332c in the-X direction may be parallel to the X-Z plane and may be perpendicular to or intersect with the X-Y plane or the Y-Z plane. Or the plane extending the first step portion 332c in the −X direction may be parallel to the X-axis and may be perpendicular to or intersect with the Y-axis or the Z-axis.

For example, the plane extending the first step portion 332c in the-X direction may be aligned with the plane extending the first inclined surface 332a in the-X direction in the X-axis direction, or the plane extending the first step portion 332c in the-X direction may be continuous with the plane extending the first inclined surface 332a in the-X direction. Alternatively, the plane extending the first step portion 332c in the −X direction may be the same as the plane extending the first inclined surface 332a in the-X direction. In another example, when the first step portion 332c is a protruding member from the first inclined surface 332a, at least one surface of the first step portion 332c may be continuous with the plane extending the first inclined surface 332a in the −X direction. Further, the plane extending the first inclined surface 332a in the −X direction and at least one surface of the first step portion 332c may be parallel to the X-Z plane. In one example, the second inclined surface 332b may connect a surface parallel to the X-Z plane among the regions of the first inclined surface 332a extended in the −X direction to a surface of the second step portion 332d that is parallel to the X-Z plane. Or the second inclined surface 332b may connect one end of the first inclined surface 332a to a surface of the second step portion 332d that is parallel to the X-Z plane.

The end portion of the pressure rod 143 may be in contact with the first inclined surface 332a at the initial position, while contacting the first step portion 332c, for example, a side surface of the first step portion 332c. The initial position may be in a state in which no force is applied to press the pressed member 141.

In an embodiment, the end portion of the pressure rod 143 may be provided to be round, and the end portion of the pressure rod 143 may include a curve. According to this, in a state in which the first inclined surface 332a of the rotation block 332 is in contact with the end portion of the pressure rod 143, the rotation block 332 may easily rotate. The end portion of the pressure rod 143 may press the rotation block 332 in the-X-direction.

The first inclined surface 332a may have the highest height in the X-axis direction in a region connected to the first step portion 332c or a region closest to the first step portion 332c and may have the lowest height in the X-axis direction in a region connected to the second step portion 332d or a region closest to the second step portion 332d.

The first inclined surface 332a may be a region connecting the first step portion 332c to the second step portion 332d. The first inclined surface 332a may be inclined at a certain angle with respect to the Y-axis (or X-axis) and the Z-axis and may be inclined linearly.

In an embodiment, the first inclined surface 332a may form a portion of the perimeter of the rotation block 332 in the Y-Z plane, and the second inclined surface 332b may form the remaining perimeter of the rotation block 332. The second inclined surface 332b may have the lowest height in the X-axis direction in a region connected to the first step portion 332c and may have the highest height in the X-axis direction in a region connected to the second step portion 332d.

The second inclined surface 332b may be inclined at a certain angle with respect to the Y-axis (or X-axis) and the Z-axis and may be inclined linearly. The second inclined surface 332b may be inclined at an opposite slope to the first inclined surface 332a.

The pressure rod 143 may be in a state facing the first inclined surface 332a and the first step portion 332c in the normal state and may be in a state in which movement to the second inclined surface 332b is limited by the first step portion 332c. Here, the normal state may be a state in which force pressing the pressed member 141 is not applied.

When force pressing the pressed member 141 is applied, the rotation block 332 may rotate in the clockwise direction D1 based on the X-axis as a rotation axis in the Y-Z plane. Here, the first inclined surface 332a may be in a state of contacting the pressure rod 143.

When the rotation block 332 rotates and the pressure rod 143 comes into contact with the second step portion 332d, for example, the side surface of the second step portion 332d, the clockwise rotation of the rotation block 332 may be limited. In this state, the anti-separation region 121 may not protrude to the outside of the support member 110.

Conversely, when force pressing the pressed member 141 is removed, the rotation block 332 may rotate in the counterclockwise direction about the X-axis as a rotation axis in the Y-Z plane by the elastic restoring force of the torsion spring 334. Here, the rotation block 332 may be in a state in which the first inclined surface 332a is in contact with the pressure rod 143. Therefore, the pressure rod 143 may be pushed in the +X-direction by the rotation of the rotation block 332.

Specifically, as the rotation block 332 rotates in the counterclockwise direction, a contact region between the pressure rod 143 and the first inclined surface 332a may move to a region close to the first step portion 332c. Accordingly, the height of the first inclined surface 332a in contact with the pressure rod 143 in the X-axis direction gradually increases, and accordingly, the rotation block 332 may push the pressure rod 143 or the pressed member 141 in the +X-direction.

Therefore, as the pressure rod 143 is closer to the first step portion 332c, the rotation block 332 may push the pressure rod 143 in the +X-direction due to the increase in the height of the first inclined surface 332a in the X-axis direction.

Therefore, the pressed member 141 may be restored to the initial position, which is a position before force for pressing the pressed member 141 is applied. When the pressed member 141 is restored to the initial position, the anti-separation member 120 may be in a state of protruding outward from the support member 110.

The configuration of the driving unit 130 described above may be replaced with an eccentric cam (CAM) or the like.

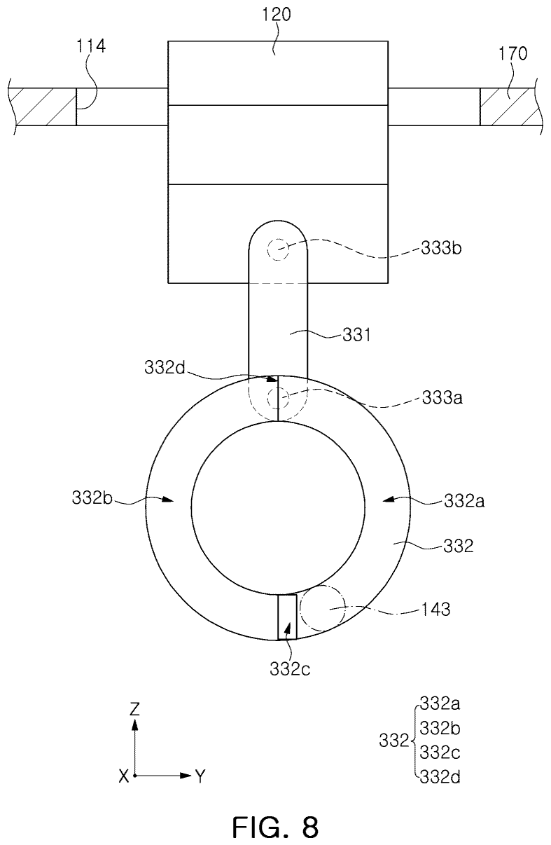

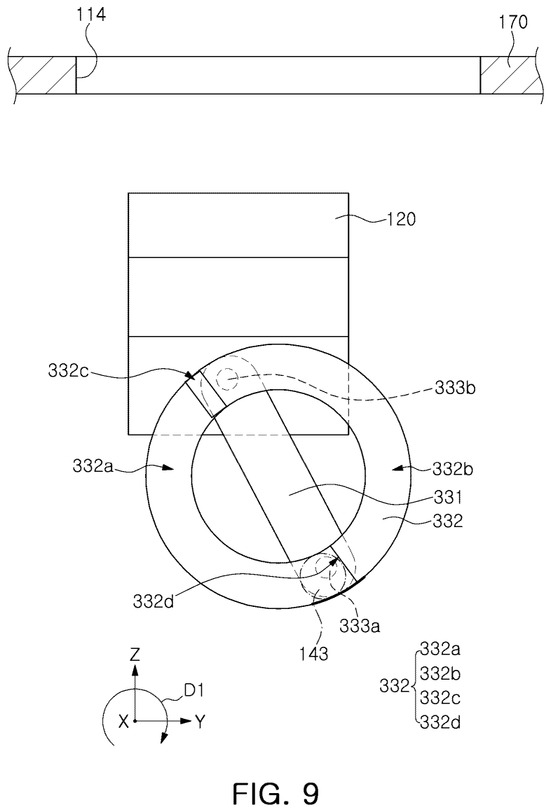

FIG. 8 is a side view illustrating a position of the pressure rod 143 when force pressing the pressed member 141 is not applied, and FIG. 9 is a side view illustrating a position of the pressure rod 143 when force pressing the pressed member 141 is applied.

Referring to FIGS. 8 and 9, the description of the driving unit 130 is supplemented. FIG. 8 is a side view of a state in which the anti-separation member 120 protrudes outside the support member 110, and FIG. 9 is a side view of a state in which the anti-separation member 120 does not protrude to the outside of the support member 110.

In an embodiment, a first driving shaft may include a hinge or pin, and a second driving shaft may also include a hinge or pin. However, the first driving shaft and the second driving shaft may be replaced with other components.

First, as illustrated in FIG. 8, when the pressure rod 143 is in contact with the side surface of the first step portion 332c, the anti-separation member 120 may protrude outward from the support member 110, so that the anti-separation region 121 may be exposed to the outside of the support member 110.

As illustrated in FIG. 9, when force is applied to press the pressed member 141, the rotation block 332 may rotate in the clockwise direction D1, while the first inclined surface 332a is in contact with the pressure rod 143. Here, the driving shaft 331 may also rotate in the Y-Z plane. The rotation of the rotation block 332 is transmitted to the anti-separation member 120 by the driving shaft 331, and the anti-separation member 120 may be lowered in the-Z-direction by the driving shaft 331. Here, the anti-separation member 120 may be introduced into the hollow portion 113.

When force pressing the pressed member 141 is removed, the rotation block 332 may rotate in the counterclockwise direction, while the first inclined surface 332a contacts the pressure rod 143. The rotation block 332 may rotate until the pressure rod 143 contacts the first step portion 332c or the side surface of the first step portion 332c. This may be possible due to elastic restoring force of the torsion spring 334.

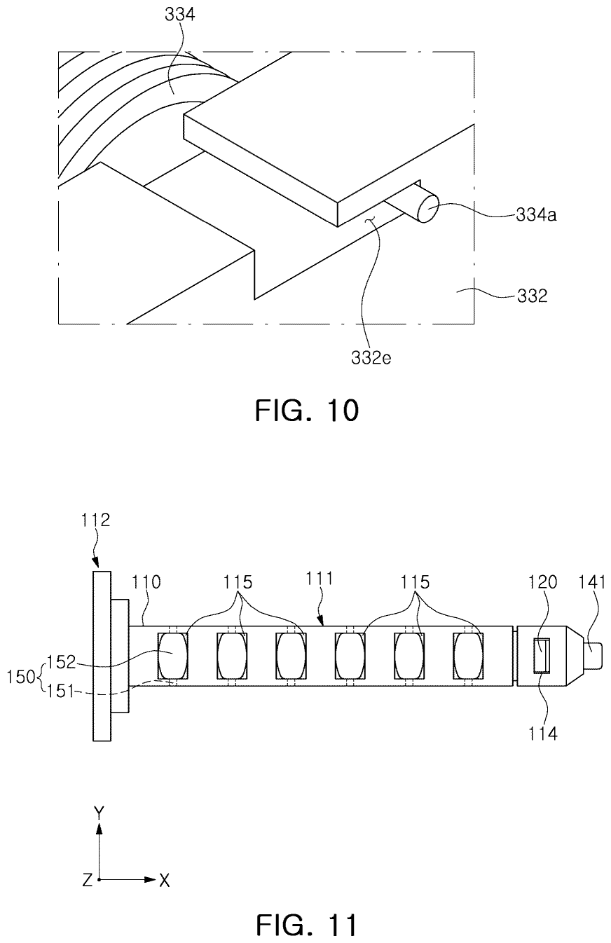

FIG. 10 is a perspective view illustrating a portion of a rear surface of the rotation block 332 according to an embodiment of the present disclosure, illustrating a joint portion of the torsion spring 334 and the rotation block 332.

As illustrated in FIGS. 10 and 6, one end portion 334a of the torsion spring 334 may be connected to the rotation block 332, and the other end portion (334b of FIG. 6) thereof may be connected to the second support bracket 335.

The torsion spring 334 may be twisted about the X-axis as a rotation axis by the rotation of the rotation block 332, while being supported by the second support bracket 335 of the rotation block 332. In addition, when force of twisting the torsion spring 334 is removed, the torsion spring 334 may be returned to its original position by elastic restoring force.

In the process of the torsion spring 334 returning to the original position, the rotation block 332 may be rotated. When force pressing the pressed member 141 is removed, the rotation block 332 may be rotated by the elastic restoring force of the torsion spring 334 and returned to the initial position.

The initial position may be a position before force pressing the pressed member 141 in the −X-direction is applied, at which the pressure rod 143 of the pressed member 141 may be in contact with a highest point in the X-axis direction on the first inclined surface 332a or the first step portion 332c.

As illustrated in FIGS. 6 and 7, at the twisted position of the torsion spring 334, force pressing the pressed member 141 in the −X-direction is applied, at which the pressure rod 143 of the pressed member 141 may be in contact with the lowest point in the X-axis direction on the first inclined surface 332a or the second step portion 332d.

As illustrated in FIGS. 6 and 10, in an embodiment, a support recess 332e into which one end portion 334a of the torsion spring 334 is inserted may be provided on a rear surface of the rotation block 332.

In addition, as an example, in a state in which one end portion 334a of the torsion spring 334 is inserted into the support recess 332e, the one end portion 334a may be additionally fixed by an adhesive, tape, bearing, or the like. However, this is not necessarily limited by the present disclosure.

The second support bracket 335 may also include another support recess into which the other end portion 334b of the torsion spring 334 is inserted, and the other end portion 334b of the torsion spring 334 may be fixed to the second support bracket 335 by an adhesive, a tape, a bearing, or the like.

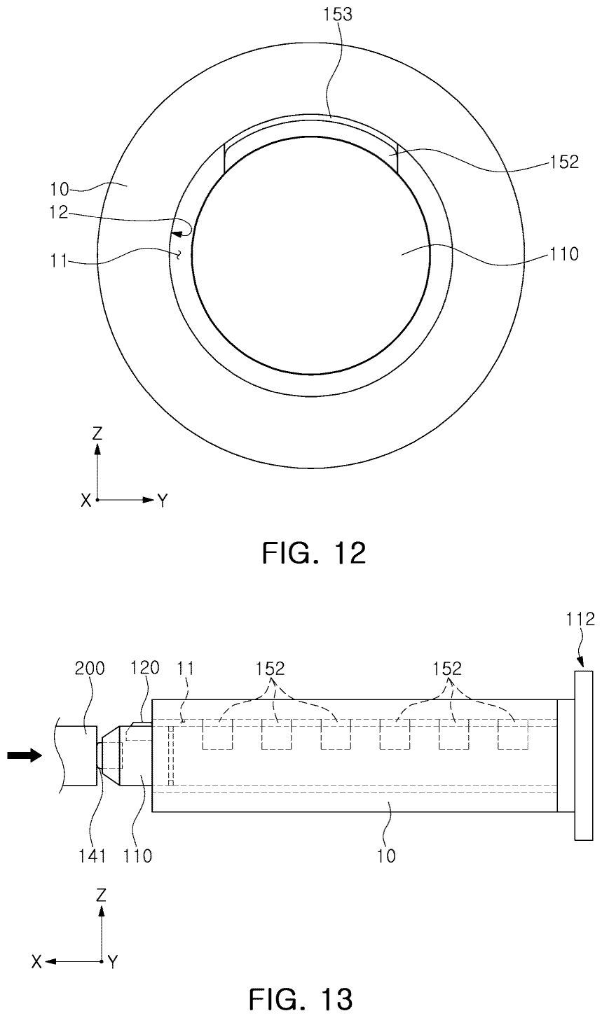

FIG. 11 is a schematic plan view of the support member 110 according to another embodiment of the present disclosure, and FIG. 12 is a schematic right side view of FIG. 11.

As illustrated in FIGS. 11 and 12, in another embodiment of the present disclosure, the support member 110 may include at least one second through-hole 115 and a moving guide portion 150 disposed in the second through-hole 115 and having at least a portion exposed to the outside of the support member 110 and contacting the target object 10.

In an embodiment, at least one second through-hole 115 may include a plurality of second through-holes 115. The plurality of second through-holes 115 may be arranged in the length direction (the X-axis direction) of the support member 110.

The plurality of second through-holes 115 may be disposed between the connection portion 112 and the first through-hole 114. The first through-hole 114 may be disposed between the second through-hole 115 and the pressed member 141.

In an embodiment, the moving guide portion 150 may be provided in plural and the plurality of moving guide portions may be arranged in the plurality of second through-holes 115, respectively.

The moving guide portions 150 may be disposed in parallel in a direction in which the target object 10 is inserted into the support member 110 to facilitate the insertion of the target object 10 into the support member 110. The moving guide portion 150 may reduce friction between the target object 10 and the support member 110 when the target object 10 is inserted into the support member 110, thereby facilitating the insertion of the target object 10 into the support member 110.

When the target object 10 comes into contact with the moving guide portion 150, the anti-separation member 120 may be introduced into the first through-hole 114 and positioned inside the support member 110. Therefore, when the target object 10 is inserted into the support member 110, interference between the target object 10 and the anti-separation member 120 may be prevented.

In an embodiment, the moving guide portion 150 may include a guide rotation shaft 151 connected to the support member 110 and a moving guide roller 152 supported by the guide rotation shaft 151.

The guide rotation shaft 151 may support the moving guide roller 152 and may be disposed in a direction parallel to the Y-axis. The guide rotation shaft 151 may be coupled to the moving guide roller 152 by a bearing or the like and may support the moving guide roller 152 so that the moving guide roller 152 may be freely rotated.

The tolerance between the guide rotation shaft 151 and a hole into which the guide rotation shaft 151 provided in the moving guide roller 152 is inserted may have a loose fit tolerance. According to this, the free rotation of the moving guide roller 152 coupled to the guide rotation shaft 151 may be facilitated.

The moving guide roller 152 supported on the guide rotation shaft 151 may rotate based on the guide rotation shaft 151 as a rotation axis.

The moving guide roller 152 may have an outer surface exposed to the outside of the support member 110, and at least a portion of the moving guide roller 152 including the outer surface of the moving guide roller 152 may protrude to the outside of the support member 110.

The outer surface of the moving guide roller 152 may come into contact with the target object 10. The moving guide roller 152 may rotate by the target object 10 when the target object 10 is inserted into the support member 110.

When the target object 10 is inserted into the support member 110, the moving guide roller 152 may rotate based on the Y-axis as a rotation axis in FIG. 11. Here, the moving guide roller 152 may rotate in the counterclockwise direction. Accordingly, when the target object 10 is inserted, friction with the support member 110 may be reduced.

When the target object 10 escapes from the support member 110, the moving guide roller 152 may rotate based on the Y-axis as a rotation axis in FIG. 11. Here, the moving guide roller 152 may rotate in the clockwise direction Accordingly, when the target object 10 escapes or removed from the support member 110, friction with the support member 110 may be reduced.

According to the above, the present disclosure may contribute to improving the efficiency of the operation of supporting the target object 10. In addition, the present disclosure may contribute to securing the safety of the operator by reducing the energy consumption of the operator performing the support operation and reducing the load of the target object 10 that the operator has to bear.

In an embodiment, the moving guide roller 152 may include a buffer member 153 on the outer surface. The buffer member 153 may come into contact with the target object 10 and may absorb the shock applied to the support member 110 and the moving guide roller 152 by the target object 10.

For example, the buffer member 153 may include an elastic buffer member. In addition, as an example, the buffer member may include a resin, such as foamed polyethylene.

The second through-hole 115 may be spaced apart from the buffer member 153, and thus interference between the moving guide roller 152 and the second through-hole 115 may be prevented.

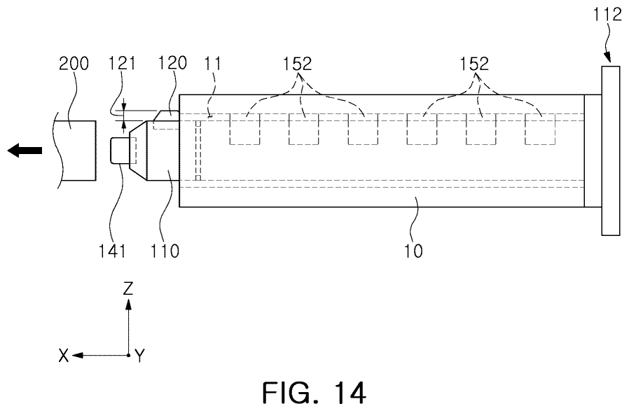

FIG. 13 schematically illustrates a state in which the target object 10 is supported by the support member 110 according to an embodiment of the present disclosure, illustrating a state in which a pressure member 200 presses the pressed member 141, and FIG. 14 illustrates a state in which the pressure member 200 releases the pressure of the pressed member 141.

As illustrated in FIGS. 13 and 14, the pressed member 141 may be pressed by the pressure member 200 or the like. The pressure member 200 may press the pressed member 141 in the −X-direction., while the pressure member 200 presses the pressed member 141, the anti-separation member 120 may not protrude to the outside of the target object 10.

While the pressure member 200 presses the pressed member 141, the core 11 of the target object 10 may be inserted into the support member 110. The core 11 of the target object 10 may be inserted from the end portion of the support member 110 in the +X-direction and may move along the support member 110 in the −X-direction.

In an embodiment, a width or diameter of the pressure member 200 in the Z-axis direction may be less than a width or diameter of the core 11 of the target object 10 in the Z-axis direction.

The inner surface (12 of FIG. 12) of the target object 10 may be in contact with the moving guide roller 152, and the moving guide roller 152 may be rotated by the movement of the target object 10 in the −X-direction.

When the operation of inserting the target object 10 into the support member 110 is completed, force of pressing the pressed member 141 may be removed by moving the pressure member 200 in the +X-direction. Then, the anti-separation member 120 may protrude to the outside of the support member 110.

The height of the end portion of the anti-separation member 120 in the +Z-direction from the outside of the support member 110 may be higher than the height of an outer line of the core 11 of the target object 10 in the +Z-direction. For example, the height of the anti-separation region 121 in the Z-axis direction may exceed a distance between the outer surface of the support member 110 and the inner surface (12 in FIG. 12) of the target object 10 in the Z-axis direction. In addition, the anti-separation member 120 may face the side surface of the target object 10 outside the support member 110. Accordingly, the target object 10 may be supported by the support member 110, while the target object 10 may be prevented from escaping from the support member 110.

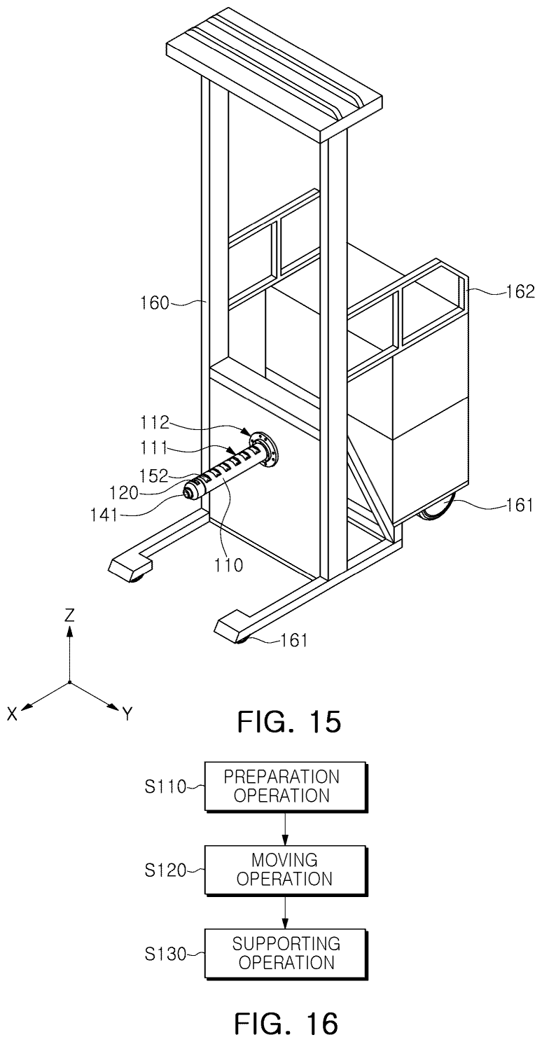

FIG. 15 is a schematic perspective view of a support apparatus according to another embodiment of the present disclosure.

As illustrated in FIG. 15, in an embodiment of the present disclosure, the support apparatus may further include a carriage body 160 to which the support member 110 is fixed.

The carriage body 160 may support the support member 110 so that the pressed member 141 may be pressed in the −X-direction.

The connection portion 112 of the support member 110 may be connected to the carriage body 160. A bolt or the like may be inserted into the connection portion 112 of the support member 110, and the bolt may be fixed to the carriage body 160. However, the method of fixing the support member 110 to the carriage body 160 is not necessarily limited by the present disclosure. When the support member 110 is fixed to the carriage body 160, the target object 10 may be supported on the support region 111 of the support member 110.

In an embodiment, the carriage body 160 may include at least one moving wheel 161. The at least one moving wheel 161 may include a plurality of moving wheels 161 and may be provided on a lower surface of the carriage body 160 in the −Z-direction.

The moving wheel 161 may facilitate movement of the carriage body 160. Accordingly, while the carriage body 160 is moved along the manufacturing process of the target object 10, the target object 10 may be supported on the support member 110.

In an embodiment, the carriage body 160 may further include a handle portion 162. The handle portion 162 may be connected to the carriage body 160 and may be gripped by the operator. The operator may facilitate the movement of the carriage body 160 through the handle portion 162.

In addition, as illustrated in FIGS. 14 and 15, in an embodiment, a pressure member supporting carriage body 160 supporting the pressure member 200 may be further provided. Accordingly, the pressure member 200 may also be easily moved along the support member 110, and the convenience of operation may be improved.

In an embodiment, the pressure member 200 may be connected to a hydraulic or pneumatic cylinder, a robot arm, or the like, and may receive power from the cylinder or robot arm. Accordingly, the load borne by the operator may be eliminated, and the safety of the operator's work may be secured.

FIG. 16 schematically illustrates a support method according to an embodiment of the present disclosure.

As illustrated in FIGS. 16, 13, and 1, the support method according to an embodiment of the present disclosure may include a preparation operation (S110) of pressing the pressing portion 140 exposed to the outside of the support member 110 to move the anti-separation member 120 into the inside of the support member 110, a moving operation (S120) of moving the target object 10 to the support member 110, while pressing the pressing portion 140, and a supporting operation (S130) of releasing the pressing of the pressing portion 140 to expose the anti-separation member 120 to the outside of the support member 110.

The preparation operation (S110) may be performed by pressing the pressed member 141 of the pressing portion 140 with the pressure member 200 or the like. When the anti-separation member 120 is moved to the inside of the support member 110 by pressing the pressed member 141, the moving operation (S120) may be performed.

In a state in which the anti-separation member 120 is moved to the inside of the support member 110 by pressing the pressed member 140, the target object 10 may be inserted into the support member 110 and the target object 10 may be moved along the support member 110.

Thereafter, the supporting operation (S130) may be performed, and the pressing of the pressed member 141 may be released by the pressure member 200 so that the anti-separation member 120 may protrude to the outside of the support member 110. In this state, the target object 10 may be supported by the support member 110, while being prevented from escaping from the support member 110.

In an embodiment, in the moving operation (S120), the target object 10 may be moved in the length direction of the support member 110, while the target object 10 is in contact with the moving guide roller 152 provided in the support member 110.

The moving guide roller 152 may be rotated by the target object 10, and, while the target object 10 is inserted into the support member 110, friction between the target object 10 and the support member 110 may be reduced.

According to an aspect of the present disclosure, the efficiency of the operation of supporting a target object, such as an electrode plate, may be improved.

In addition, according to an aspect of the present disclosure, the safety of the operation of supporting the target object may be improved.

In addition, the present disclosure may be widely applied in green technology fields, such as solar power generation and wind power generation.

In addition, the present disclosure may be applied to eco-friendly devices, such as eco-friendly electric vehicles and hybrid vehicles to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

What is claimed is:

1. A support apparatus comprising:
a support member into which a target object is inserted;
an anti-separation member in which an anti-separation region, at least a portion of the anti-separation member, is exposed to the outside of the support member;
a driving unit connected to the anti-separation member; and
a pressing portion connected to the driving unit and having at least a portion exposed to the outside of the support member,
wherein the driving unit moves the anti-separation member when the pressing portion is pressed.

2. The support apparatus of claim 1, wherein
the anti-separation region faces the target object from the outside of the support member, and
when the pressing portion is pressed, the driving unit moves the anti-separation region such that the anti-separation region does not face the target object.

3. The support apparatus of claim 1, wherein
the support member includes:
a hollow portion provided inside the support member; and
a first through-hole into which the anti-separation member is inserted,
wherein the driving unit is disposed in the hollow portion.

4. The support apparatus of claim 1, wherein the driving unit returns the anti-separation member to an initial position of the anti-separation member when pressing force is released from the pressing portion.

5. The support apparatus of claim 1, wherein
the support member includes:
at least one second through-hole; and
a moving guide portion disposed in the at least one second through-hole, at least a portion of the moving guide portion being exposed to the outside of the support member and contacting the target object.

6. The support apparatus of claim 5, wherein
the at least one second through-hole includes a plurality of second through-holes arranged in a length direction of the support member, and
the moving guide portion is provided in plural and the plurality of moving guide portions are arranged in the plurality of second through-holes, respectively.

7. The support apparatus of claim 6, wherein
the moving guide portion includes:
a guide rotation shaft connected to the support member; and
a moving guide roller supported by the guide rotation shaft.

8. The support apparatus of claim 3, wherein
the driving unit includes:
a first driving link disposed in the hollow portion and connected to the anti-separation member;
a second driving link connected to the first driving link and the pressing portion; and
an elastic support portion disposed in the hollow portion and connected to the second driving link and the support member.

9. The support apparatus of claim 8, wherein
the elastic support portion includes:
a first fixed block fixed to the support member;
a first elastic member having one side connected to the first fixed block and the other side connected to the second driving link;
a second fixed block fixed to the support member; and
a second elastic member having one side connected to the second fixed block and the other side connected to the second driving link.

10. The support apparatus of claim 8, wherein the driving unit further includes at least one stopper member disposed in the hollow portion and limiting movement of the pressing portion and the second driving link.

11. The support apparatus of claim 3, wherein
the driving unit includes:
a driving shaft disposed in the hollow portion and connected to the anti-separation member;
a rotation block connected to the driving shaft and pressed by the pressing portion to be rotated; and
a torsion spring connected to the rotation block and the support member.

12. The support apparatus of claim 11, wherein
the pressing portion includes a pressed member including a pressure rod pressing the rotation block, and
the rotation block includes:
a first inclined surface in contact with the pressure rod and is inclined; and
a first step portion connected to one side of the first inclined surface and protruding in a length direction of the rotation block.

13. The support apparatus of claim 12, wherein the anti-separation region is disposed in the hollow portion when the rotation block completes rotation in a clockwise direction and is disposed outside the support member when the rotation block completes rotation in a counterclockwise direction.

14. The support apparatus of claim 1, further comprising a carriage body to which the support member is fixed.

15. The support apparatus of claim 14, wherein the carriage body includes at least one moving wheel.

16. The support apparatus of claim 7, wherein the moving guide roller includes a buffer member on an outer surface of the moving guide roller.

17. A support method comprising:
a preparation operation of pressing a pressing portion exposed to the outside of a support member to move an anti-separation member into the inside of the support member to support a target object;
a moving operation of moving the target object to the support member, while the pressing portion is being pressed; and
a supporting operation of releasing the pressing of the pressing portion to expose the anti-separation member to the outside of the support member.

18. The support method of claim 17, wherein the moving operation includes moving the target object in a length direction of the support member in a state in which the target object is brought into contact with a moving guide roller provided in the support member.
